(19) United States
(12) Patent Application Publication
(10) Pub. No.: US 2014/0208905 A1
(43) Pub. Date: Jul. 31, 2014

(54) METHOD AND APPARATUS FOR FABRICATING STRETCH FILM ROLLS

(71) Applicant: Anthony Galea, Markham (CA)

(72) Inventor: Anthony Galea, Markham (CA)

(21) Appl. No.: 13/755,532

(22) Filed: Jan. 31, 2013

(51) Int. Cl. B26D 7/00

(52) U.S. Cl. CPC B26D 7/00
USPC 83/156

(57) ABSTRACT

An apparatus for fabricating stretch film rolls comprises a plurality of cutting blades for cutting a stretch film web into one or more stretch film web sections, the plurality of cutting blades being configured to be oscillated. The apparatus also comprises a driven winding shaft for winding the one or more stretch film web sections.

### FIELD OF THE INVENTION

The present invention relates generally to stretch film and in particular, to a method and apparatus for fabricating stretch film rolls.

### BACKGROUND OF THE INVENTION

Stretch film is widely used for wrapping and securing pallet loads for shipping. This is due to the fact that stretch film exhibits a “memory”, or a tendency to shrink, upon stretching. For example, stretch film that is stretched by an amount of 10% will shrink nearly 10% of its stretched length. This “memory” assists in securing wrapped palletized articles together under compression.

Stretch film is fabricated in the form of stretch film rolls. Each stretch film roll may be used to manually wrap a pallet load, or may be loaded into an automated wrapping machine.

An issue with conventional stretch film rolls is that the stretch film wound within the roll can become damaged if the stretch film roll is dropped or otherwise mishandled. For example, dropping the stretch film roll on its edge can result in tearing of the stretch film during wrapping of a pallet load.

One approach to avoiding such tearing involves folding the longitudinal edges of the stretch film prior to winding, so as to provide a stretch film having reinforced longitudinal edges within the stretch film roll. Methods of folding the longitudinal edges of stretch film prior to winding have been described. For example, U.S. Pat. No. 5,520,872 to Scherer discloses a strip of stretch-wrap material having flat, double thickness hems at opposite margins thereof. The hemmed strip is formed on an apparatus including a first roller having a width less than the width of stock material, whereby opposite margins of the stock material project beyond opposite ends of the roller, and a second roller for guiding the strip at an acute angle from the first roller for causing opposite marginal portions to fold. The strip is maintained under tension by a take-up roller or other means, and guide bars are provided for further folding the marginal portions past 90 degree angles so that they continue to be folded inwardly against the main body of the strip.

Another approach to avoiding tearing involves oscillating the stretch film during winding, so as to prevent formation of hard edges within the stretch film roll. Methods of oscillating stretch film during winding have been described. For example, U.S. Pat. No. 5,967,437 to Martin-Cocher et al. discloses a method of manufacturing rolls of pre-stretched film that comprises importing oscillation to the film with a component perpendicular to the film axis. During pre-stretching and winding of the film on a take-up roll, a feed roll, namely a spool from which the stretchable film for stretching is taken, is caused to oscillate, and/or the take-up core is caused to oscillate.

Improvements are generally desired. It is therefore an object at least to provide a novel method and apparatus for fabricating stretch film rolls.

### SUMMARY OF THE INVENTION

In one aspect, there is provided an apparatus for fabricating stretch film rolls, comprising: a plurality of cutting blades for cutting a stretch film web into one or more stretch film web sections, the plurality of cutting blades being configured to be oscillated; and a driven winding shaft for winding the one or more stretch film web sections.

Each stretch film web section may have non-linear longitudinal edges.

Each stretch film web section may be wound onto a core supported by the winding shaft.

The plurality of cutting blades may be configured to be oscillated along an axis that is generally orthogonal to a direction of travel of the stretch film web.

The plurality of cutting blades may be configured to be oscillated over a fixed distance. The plurality of cutting blades may be configured to be oscillated over a variable distance.

The plurality of cutting blades may be configured to be oscillated at a fixed frequency. The plurality of cutting blades may be configured to be oscillated at a variable frequency.

The apparatus may further comprise a roller positioned adjacent the winding shaft, a wound surface of the one or more stretch film web sections being in contact with a surface of the roller. The roller may be configured as a driven roller. The roller may be configured as an idler roller.

In another aspect, there is provided a method for fabricating stretch film rolls, comprising: providing a stretch film web; cutting the stretch film web using a plurality of cutting blades into one or more stretch film web sections, the plurality of cutting blades being oscillated during the cutting; and winding the one or more stretch film web sections.

The cutting may further comprise forming non-linear longitudinal edges within each stretch film web section.

The winding may further comprise winding each stretch film web section onto a core.

The plurality of cutting blades may be configured to be oscillated along an axis that is generally orthogonal to a direction of travel of the stretch film web.

The plurality of cutting blades may be configured to be oscillated over a fixed distance during the cutting. The plurality of cutting blades may be configured to be oscillated over a variable distance during the cutting.

The plurality of cutting blades may be configured to be oscillated at a fixed frequency during the cutting. The plurality of cutting blades may be configured to be oscillated at a variable frequency during the cutting.

In still another aspect, there is provided a method for cutting stretch film during fabrication of stretch film rolls, comprising: cutting a stretch film web using a plurality of cutting blades into one or more stretch film web sections, the plurality of cutting blades being oscillated during the cutting.

The cutting may further comprise forming non-linear longitudinal edges within each stretch film web section.

The plurality of cutting blades may be configured to be oscillated along an axis that is generally orthogonal to a direction of travel of the stretch film web.

### BRIEF DESCRIPTION OF THE DRAWINGS

Embodiments will now be described more fully with reference to the accompanying drawings in which:

FIG. 1 is a side view of a portion of an apparatus for fabricating stretch film rolls, during use;

FIG. 2 is a schematic front view of a cutting station forming part of the apparatus of FIG. 1, during use; and

FIG. 3 is a side view of a stretch film roll fabricated using the apparatus of FIG. 1.

### DETAILED DESCRIPTION OF THE EMBODIMENTS

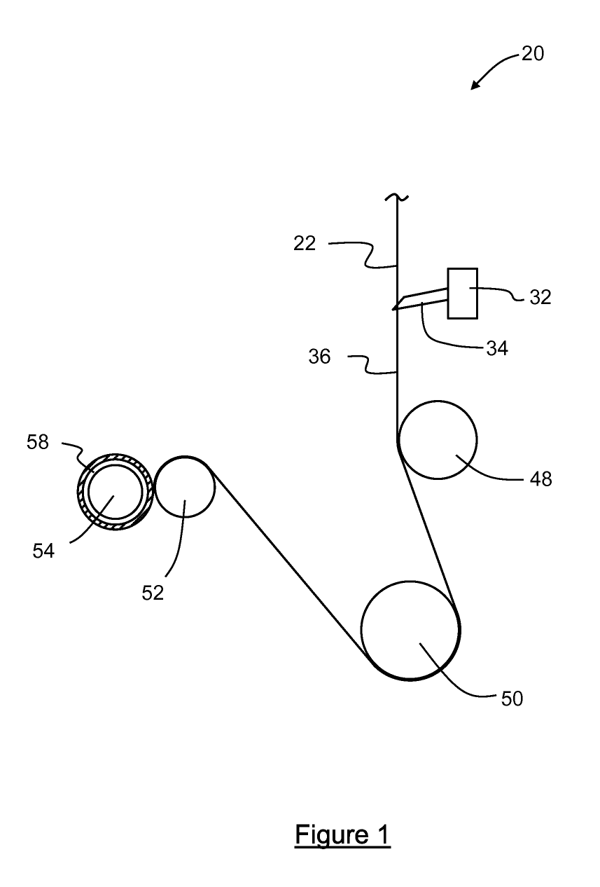

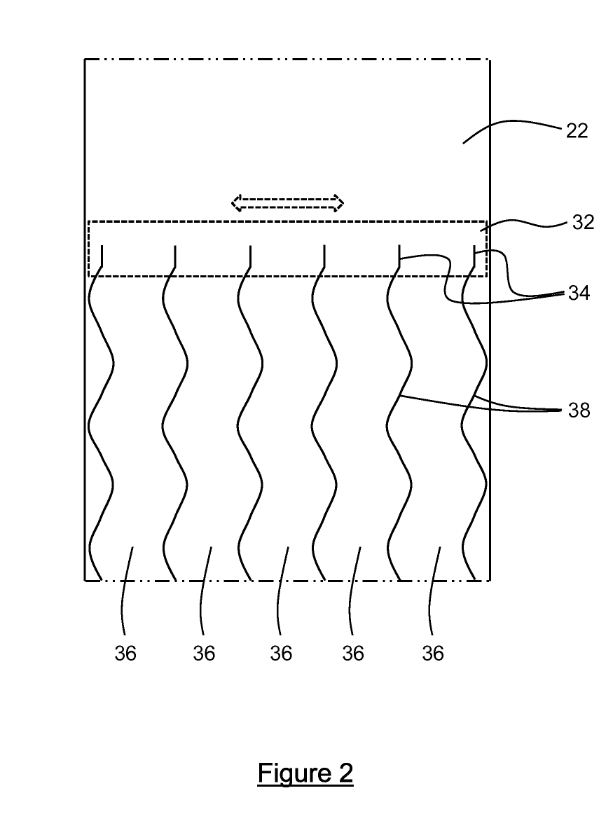

Turning now to FIGS. 1 and 2, a portion of an apparatus for fabricating stretch film rolls is shown, and is generally indicated by reference numeral 20. Apparatus 20 comprises an extruder (not shown) that is configured to dispense a continuous sheet of plastic film onto a surface of a rotating cast roller (not shown) so as to form a stretch film web 22. Apparatus 20 also comprises a set of rollers (not shown) configured to receive the stretch film web 22 from the cast roller.

Apparatus 20 further comprises a cutting station 32 that is positioned downstream from the set of rollers. The cutting station 32 comprises a plurality of cutting blades 34 that are configured to cut, or “slit”, the stretch film web 22 into a plurality of stretch film web sections 36. At least one assembly (not shown) is provided for oscillating the cutting station 32, together with the cutting blades 34, along an oscillation axis that is generally orthogonal to the direction of travel of the stretch film web 22. In this embodiment, the cutting station 32 is oscillated at a fixed frequency and over a fixed distance along the oscillation axis. In this embodiment, the fixed frequency is a frequency in the range from 0 cycles per minute to about 200 cycles per minute, and the fixed distance, and namely the distance traveled during one cycle, is a distance in the range from 0 inches to about 4 inches.

In the embodiment shown, apparatus 20 further comprises a first intermediate roller 48 that is configured to receive the stretch film web sections 36 downstream from the cutting station 32, and a second intermediate roller 50 that is configured to receive the stretch film web sections 36 from the first intermediate roller 48. In this embodiment, the first intermediate roller 48 and the second intermediate roller 50 are idler rollers.

Apparatus 20 further comprises a roller 52 that is configured to receive the stretch film web sections 36 from the second intermediate roller 50. Apparatus 20 further comprises a winding shaft 54 positioned adjacent the roller 52 and supporting a plurality of cores 58. The winding shaft 54, with the cores 58 supported thereon, is configured to receive the stretch film web sections 36 from the roller 52 for winding each stretch film web section 36 onto a respective core 58, so as to form a plurality of stretch film rolls. An assembly (not shown) is provided for rotatably driving the winding shaft 54. The surface of the stretch film wound onto the cores 58 is in contact with the surface of the roller 52, so as to prevent entrapment of air between layers of the stretch film during winding. In this embodiment, the roller 52 is configured as an idler roller.

During operation, the extruder dispenses a continuous sheet of plastic film onto the surface of the rotating cast roller to form the stretch film web 22, which is then received by the set of rollers. From the set of rollers, the stretch film web 22 travels downstream to the cutting station 32, where it is engaged by the plurality of cutting blades 34 and cut into a plurality of stretch film web sections 36. The cutting station 32 and the plurality of cutting blades 34 are being oscillated along the oscillation axis. As a result of this oscillation, each stretch film web section 36 has longitudinal edges 38 that are defined by cutting lines and that are generally non-linear along the length of the stretch film web section 36, as shown schematically in FIG. 2.

Downstream from the cutting station 32, the stretch film web sections 36 are received by the first intermediate roller 48, and in turn by the second intermediate roller 50. From the intermediate roller 50, the stretch film web sections 36 are received by the roller 52, and in turn by the winding shaft 54 supporting the plurality of cores 58, at which each stretch film web section 36 is wound onto a respective core 58 so as to form a plurality of stretch film rolls.

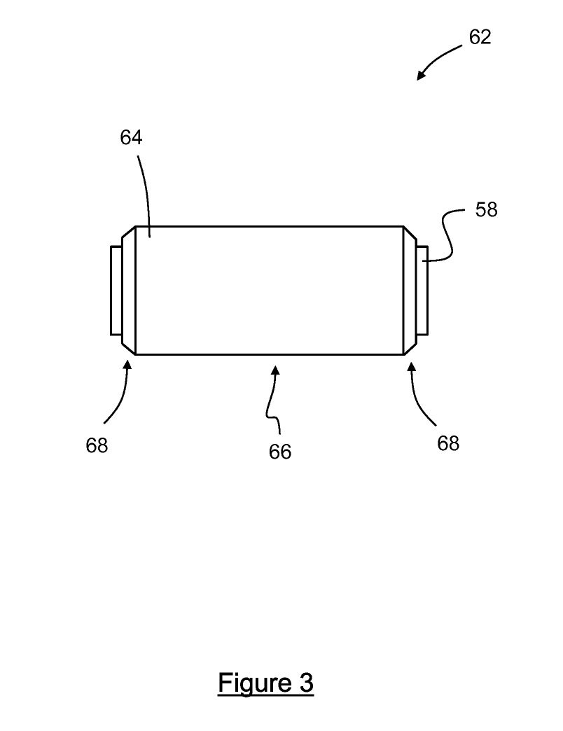

A stretch film roll fabricated by the apparatus 20 is shown in FIG. 3, and is generally indicated by reference numeral 62. Stretch film roll 62 comprises a body 64 of stretch film wound onto core 58. The body 64 of stretch film has a generally cylindrical central portion 66 and tapered end portions 68, with the end portions 68 being generally softer than the central portion 64. The configuration of the stretch film roll 62, and in particular the softness and the tapered shape of the end portions 68, results from the oscillation of the cutting blades 34 during winding onto the core 58. As will be understood, this oscillation causes the formation of longitudinal edges 38 that are generally non-linear, which prevents direct overlap of the longitudinal edges 38 during winding, and thereby eliminates the formation of hard, right-angled corners within the wound film at ends of the roll that would otherwise form in absence of oscillation. As will be appreciated, the softness and the tapered shape of the end portions 68 advantageously increases the tolerance of the stretch film roll 62 to handling errors, such as dropping, which in turn renders the stretch film within the stretch film roll 62 less prone to tearing during use.

For example, although in the embodiment described above, the cutting station is oscillated at a fixed frequency, in other embodiments, the cutting station may alternatively be oscillated at a variable frequency, such as for example, a periodically variable frequency or a random frequency.

Although in the embodiment described above, the cutting station is oscillated over a fixed distance along the oscillation axis, in other embodiments, the cutting station may alternatively be oscillated over a variable distance along the oscillation axis, such as for example, a periodically variable distance or a random distance.

Although in the embodiment described above, the fixed frequency is a frequency in the range from 0 cycles per minute to about 200 cycles per minute, in other embodiments, the fixed frequency may alternatively be a frequency that is greater than 200 cycles per minute.

Although in the embodiment described above, the fixed distance is a distance in the range from 0 inches to about 4 inches, in other embodiments, the fixed frequency may alternatively be a distance that is greater than 4 inches.

Although in the embodiment described above, the oscillation axis of the cutting station and the cutting blades is generally orthogonal to the direction of travel of the stretch film web, in other embodiments, the oscillation axis of the cutting station and the cutting blades may alternatively be non-orthogonal to the direction of travel of the stretch film web, provided that each stretch film web section has longitudinal edges defined by cutting lines that are generally non-linear along the length of the stretch film web section.

Although in the embodiment described above, the first intermediate roller and the second intermediate roller are configured as idler rollers, in other embodiments, one (1) or both of the first intermediate roller and the second intermediate roller may alternatively be configured as a driven roller.

Although in the embodiment described above, the apparatus comprises a first intermediate roller and a second intermediate roller, in other embodiments, the apparatus may alternatively comprise fewer or more intermediate rollers. In one embodiment, the apparatus may alternatively comprise no intermediate rollers.

Although in the embodiment described above, the cutting station comprises a plurality of cutting blades that are configured to cut the stretch film web into a plurality of stretch film web sections, in other embodiments, the cutting station may alternatively comprise two (2) cutting blades that are configured to cut the stretch film web into one (1) stretch film web section.

Although in the embodiment described above, the winding shaft supports a plurality of cores, in other embodiments, the winding shaft may alternatively support one (1) core.

Although in the embodiment described above, the roller adjacent the winding shaft is configured as an idler roller, in other embodiments, the roller adjacent the winding shaft may alternatively be configured as a driven roller. In one such embodiment, the surface speed of the driven roller may be matched to the surface speed of the wound film on the winding shaft using automated or computer-controlled speed matching. In another such embodiment, there may be no assembly provided for rotatably driving the winding shaft, and the winding shaft may alternatively be driven through contact with the surface of the driven roller.

Although in the embodiment described above, the apparatus comprises an extruder and a rotating cast roller for forming the stretch film web, in other embodiments, the apparatus may alternatively not comprise an extruder and a cast roller for forming the stretch film web, but may alternatively comprise means for supporting a supply (e.g. a spool, a roll, etc.) of already-formed stretch film web, and means for feeding the already-formed stretch film web from the supply to the set of rollers, or from the supply to the cutting station if no set of rollers is provided.

Although in the embodiment described above, the surface of the stretch film wound onto the cores is in contact with the surface of the roller adjacent the winding shaft so as to prevent entrapment of air between layers of the stretch film during winding, in other embodiments, the winding shaft and any roller adjacent thereto may alternatively be configured to enable entrapment of air between layers of the stretch film during winding.

In other embodiments, the cutting station comprising the plurality of cutting blades, and the at least one assembly provided for oscillating the cutting station together with the cutting blades, may alternatively form part of another apparatus used for fabricating stretch film rolls.

Although embodiments have been described above with reference to the accompanying drawings, those of skill in the art will appreciate that variations and modifications may be made without departing from the scope thereof as defined by the appended claims.

What is claimed is:

1. An apparatus for fabricating stretch film rolls, comprising:
a plurality of cutting blades for cutting a stretch film web into one or more stretch film web sections, the plurality of cutting blades being configured to be oscillated; and
a driven winding shaft for winding the one or more stretch film web sections.

2. The apparatus of claim 1, wherein each stretch film web section has non-linear longitudinal edges.

3. The apparatus of claim 1, wherein each stretch film web section is wound onto a core supported by the winding shaft.

4. The apparatus of claim 1, wherein the plurality of cutting blades is configured to be oscillated along an axis that is generally orthogonal to a direction of travel of the stretch film web.

5. The apparatus of claim 1, wherein the plurality of cutting blades is configured to be oscillated over a fixed distance.

6. The apparatus of claim 1, wherein the plurality of cutting blades is configured to be oscillated over a variable distance.

7. The apparatus of claim 1, wherein the plurality of cutting blades is configured to be oscillated at a fixed frequency.

8. The apparatus of claim 1, wherein the plurality of cutting blades is configured to be oscillated at a variable frequency.

9. The apparatus of claim 1, further comprising a roller positioned adjacent the winding shaft, a wound surface of the one or more stretch film web sections being in contact with a surface of the roller.

10. The apparatus of claim 9, wherein the roller is configured as a driven roller.

11. The apparatus of claim 9, wherein the roller is configured as an idler roller.

12. A method for fabricating stretch film rolls, comprising:
providing a stretch film web;
cutting the stretch film web using a plurality of cutting blades into one or more stretch film web sections, the plurality of cutting blades being oscillated during said cutting; and
winding the one or more stretch film web sections.

13. The method of claim 12, wherein the cutting further comprises forming non-linear longitudinal edges within each stretch film web section.

14. The method of claim 12, wherein the winding further comprises winding each stretch film web section onto a core.

15. The method of claim 12, wherein the plurality of cutting blades is configured to be oscillated along an axis that is generally orthogonal to a direction of travel of the stretch film web.

16. The method of claim 12, wherein the plurality of cutting blades is configured to be oscillated over a fixed distance during said cutting.

17. The method of claim 12, wherein the plurality of cutting blades is configured to be oscillated over a variable distance during said cutting.

18. The method of claim 12, wherein the plurality of cutting blades is configured to be oscillated at a fixed frequency during said cutting.

19. The method of claim 12, wherein the plurality of cutting blades is configured to be oscillated at a variable frequency during said cutting.

20. A method for cutting stretch film during fabrication of stretch film rolls, comprising:
cutting a stretch film web using a plurality of cutting blades into one or more stretch film web sections, the plurality of cutting blades being oscillated during said cutting.

21. The method of claim 20, wherein the cutting further comprises forming non-linear longitudinal edges within each stretch film web section.

22. The method of claim 20, wherein the plurality of cutting blades is configured to be oscillated along an axis that is generally orthogonal to a direction of travel of the stretch film web.
